(19) United States
(12) Patent Application Publication
(10) Pub. No.: US 2017/0105820 A1
(43) Pub. Date: Apr. 20, 2017

(54) SCREW AND DRIVER TOOL FOR DENTAL PROCEDURES

(71) Applicant: Implant Direct Sybron International LLC, Thousand Oaks, CA (US)

(72) Inventor: Ines Aravena, Santa Rosa Valley, CA (US)

(21) Appl. No.: 15/298,641

(22) Filed: Oct. 20, 2016

Related U.S. Application Data
(60) Provisional application No. 62/243,924, filed on Oct. 20, 2015.

(51) Int. Cl. A61C 8/00

(52) U.S. Cl. CPC A61C 8/0089; A61C 8/0068

(57) ABSTRACT

A screw and a driver tool are used in dental procedures. The screw has an apical and coronal end and comprises a bore extending from the coronal end of the screw along a portion of the screw towards the apical end. The bore includes a plurality of recesses arranged circumferentially around an inside surface of the bore, wherein each successive pair of recesses is connected by a contact surface on the inside surface of the bore. Two sets of recesses and contact surfaces may be present to allow for optimal contact with a conventional hex driver using one set and an inventive driver with the other set. The driver comprises a driver head having an apical and a coronal end. The driver head has a plurality of edges with a rounded outer shape and a plurality of surfaces extending between successive edges. The surfaces are generally concave.

### CROSS-REFERENCE TO RELATED APPLICATION

This application claims the benefit of U.S. Provisional Application No. 62/243,924, filed Oct. 20, 2015, the content of which is hereby incorporated by reference herein in its entirety.

### TECHNICAL FIELD

The present invention relates generally to screw and driver tools for dental procedures, and more particularly to screw and driver tools for screw-retained abutments in dental implant procedures.

### BACKGROUND

Edentulism, the condition of being toothless to some extent, may be treated by the implantation of a dental assembly. These assemblies require certain components to rest comfortably and securely in the patient's oral cavity. The implant fixture, also known as the dental implant or simply the implant, is the part of the dental assembly that becomes fused with the patient's jaw bone. The implant is available in both cylinder and screw-type varieties and is typically made from titanium or a titanium alloy. Implant abutments are screwed onto the implant and are positioned at and above the patient's gum line. Finally, a dental prosthesis is placed over the abutment and is designed to look and function like a natural tooth.

Alternatively, the prosthesis may be formed over the abutment outside of the patient's mouth, and the combined prosthesis and abutment may then be affixed to the implant with a fixation screw. To install the abutment and prosthesis onto the implant and to access the fixation screw during repair and maintenance of the dental assembly, the prosthesis must contain a screw access channel. In many dental assemblies, this screw access channel can reside at the labial side of the tooth or on the biting surface, which is not desired as a matter of strength and aesthetics. Because of this screw placement, the majority of fixation screws currently on the market are tightened through the abutment and into the implant at an axis that is parallel to the longitudinal axis of the implant. However, for aesthetic reasons, it is often preferable to form the screw access channel on the lingual side of the prosthesis, angled relative to the longitudinal axis of the implant.

When the screw access channel is angled relative to the longitudinal axis of the implant, however, the tool used to drive the screw must likewise be able to operate at an angle relative to that axis. One such tool has been proposed, but its technical limitations require that a large diameter fixation screw be used. Such large fixation screws are aesthetically displeasing and negatively impact the strength of the prosthesis.

Therefore, there is a need for a screw and driver tool that address the present challenges and characteristics discussed above in regard to the screw access channel placement and the ability to drive the screw at an angle relative to the longitudinal axis of the screw.

### SUMMARY OF INVENTION

To these ends, a driver tool for driving a screw for fastening a dental component to a dental implant is provided. The driver tool includes a driver shaft portion having a longitudinal axis and a driver head coupled to the shaft portion and having an apical and a coronal end. The driver head includes a plurality of edges with a rounded outer shape and a plurality of surfaces extending between successive edges. The surfaces between the edges are generally concave.

In an exemplary embodiment, the plurality of edges extends in a direction generally parallel to the longitudinal axis and may be generally convex in a direction generally parallel to the longitudinal axis. Moreover, for each of the plurality of edges, the radial extent of the edge at an intermediate region between the apical and coronal ends is greater than the radial extent of the edge at the apical and coronal ends.

In an exemplary embodiment, each of the plurality of surfaces is generally concave in a direction generally transverse to the longitudinal axis. Additionally, each of the plurality of surfaces may have a generally elliptical configuration in a direction generally parallel to the longitudinal axis. Moreover, for each of the plurality of surfaces, the width of a surface at an intermediate region between the apical and coronal ends is greater than the width of the surface at the apical and coronal ends. In one embodiment, the plurality of edges and surfaces may extend from the apical end to the coronal end of the driver head. Furthermore, in an exemplary embodiment, the driver head may include six edges and six surfaces.

A combination for fastening a dental component to a dental implant includes a screw and a driver tool. The screw includes a bore extending from the coronal end of the screw toward the apical end and a plurality of recesses circumferentially arranged on an inside surface of the bore and extending from the coronal end of the bore toward the apical end. Each successive pair of recesses is connected by a contact surface on the inside surface of the bore. The driver tool includes a driver shaft portion having a longitudinal axis and a driver head coupled to the shaft portion and having an apical and a coronal end. The driver head includes a plurality of edges with a rounded outer shape and a plurality of surfaces extending between successive edges. The surfaces between the edges are generally concave.

In one embodiment, the bore includes a first bore portion having a first set of plurality of recesses and contact surfaces, and a second bore portion having a second set of plurality of recesses and contact surfaces. The configuration of the first bore portion and the second bore portion is different from each other. The first bore portion extends from the coronal end to an intermediate region between the coronal and apical ends. The second bore portion extends from the intermediate region toward the apical end.

Further, a screw for fastening a dental component to a dental implant includes a bore extending from a coronal end of the screw toward an apical end of the screw. The bore includes a first bore portion extending from the coronal end of the screw toward an intermediate region of the bore, and a second bore portion extending from the intermediate region of the bore toward an apical end of the bore. The first bore portion includes a first set of a plurality of recesses circumferentially arranged on an inside surface of the bore, each successive pair of recesses connected by a contact surface on the inside surface of the bore. The second bore portion includes a second set of a plurality of recesses circumferentially arranged on an inside surface of the bore, each successive pair of recesses connected by a contact surface on the inside surface of the bore. The configuration of the first bore portion and the second bore portion is different from each other.

### BRIEF DESCRIPTION OF THE DRAWINGS

The accompanying drawings, which are incorporated in and constitute a part of this specification, illustrate embodiments of the invention and, together with a general description of the invention given above, and the detailed description given below serve to explain various aspects of the invention.

FIG. 1 is a diagrammatic cross-sectional view of a dental assembly with a driver tool.

FIG. 2A is a diagrammatic view of a driver tool engaging a screw.

FIG. 2B is a diagrammatic view of the components of FIG. 2A in contact with one another.

FIG. 3 is a diagrammatic cross-sectional view of a driver tool engaged with a screw taken along a longitudinal axis of the screw.

FIG. 4 is a diagrammatic cross-sectional view of a driver tool engaged with a screw taken along the 4-4 line of FIG. 3.

FIG. 5 is a diagrammatic cross-sectional view of a driver tool engaged with a screw taken along a longitudinal axis of the screw.

FIG. 6 is a diagrammatic cross-sectional view of a driver tool engaged with a screw taken along the 6-6 line of FIG. 5.

FIG. 7 is a diagrammatic view of a fixation screw in accordance with the invention.

FIG. 8 is a diagrammatic cross-sectional view of the fixation screw taken along the 8-8 line of FIG. 7.

FIG. 9 is a diagrammatic cross-sectional view of the fixation screw taken along the 9-9 line of FIG. 7.

FIG. 10 is a diagrammatic view of a driver tool.

FIG. 11 is a detail diagrammatic view of the head portion of a driver tool.

FIG. 12 is a diagrammatic cross-sectional view taken along the 12-12 line of FIG. 11.

FIG. 13 is a diagrammatic cross-sectional view taken along the 13-13 line of FIG. 11.

### DETAILED DESCRIPTION

Although the invention will be described next in connection with certain embodiments, the invention is not limited to practice in any one specific type of screw and driver tool. The description of the embodiments of the invention is intended to cover all alternatives, modifications, and equivalent arrangements as may be included within the spirit and scope of the invention as defined by the appended claims. In particular, those skilled in the art will recognize that the components of the embodiments of the invention described herein could be arranged in multiple different ways.

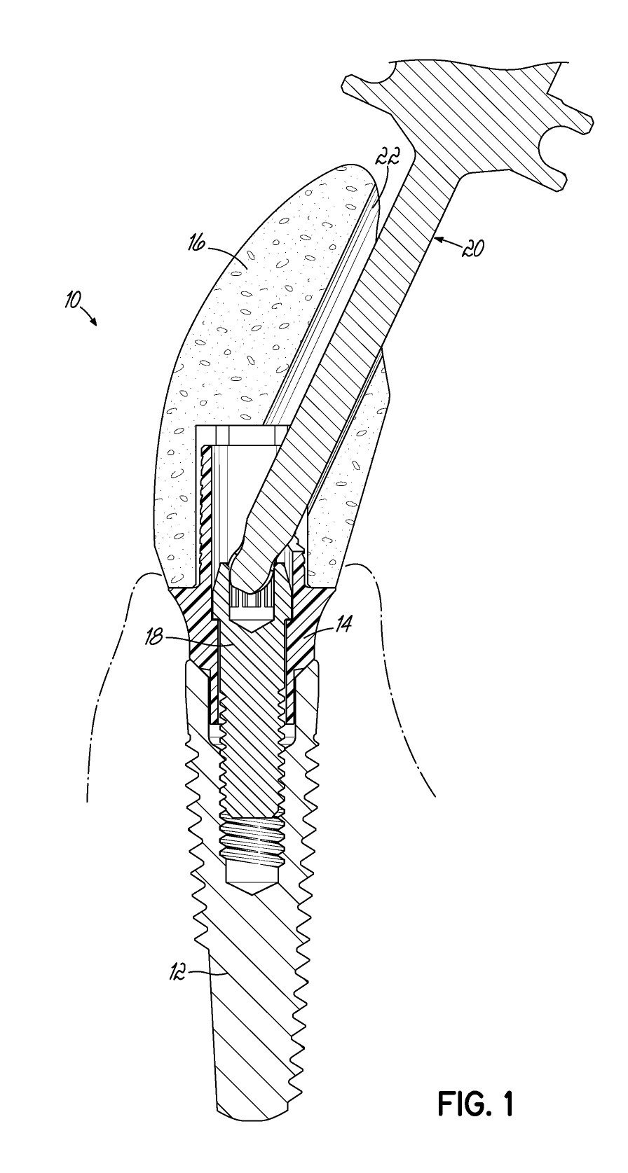

With reference now to FIG. 1, a dental assembly 10 is shown with implant 12, abutment 14, prosthesis 16, and fixation screw 18. Ball-point hex driver 20 may be used to drive fixation screw 18 through the abutment 14 and into the implant 12. The driver 20 passes through driver access channel 22. Through the use of a ball-point hex driver 20, the user may change the angle θ of the driver 20 as driver 20 is rotated to insert or remove the screw 18. Alternatively, the user may hold the angle θ steady throughout the insertion and removal procedure.

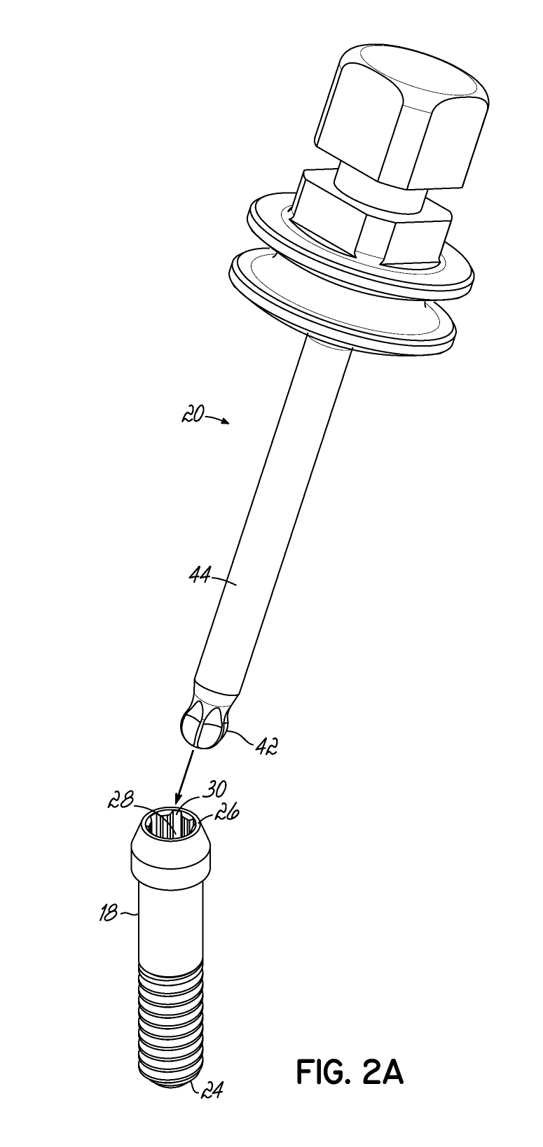

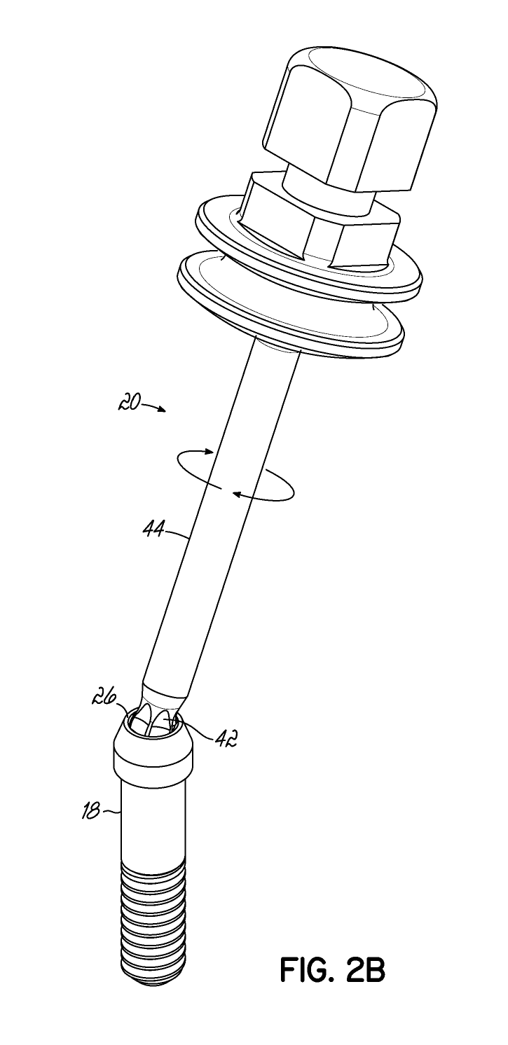

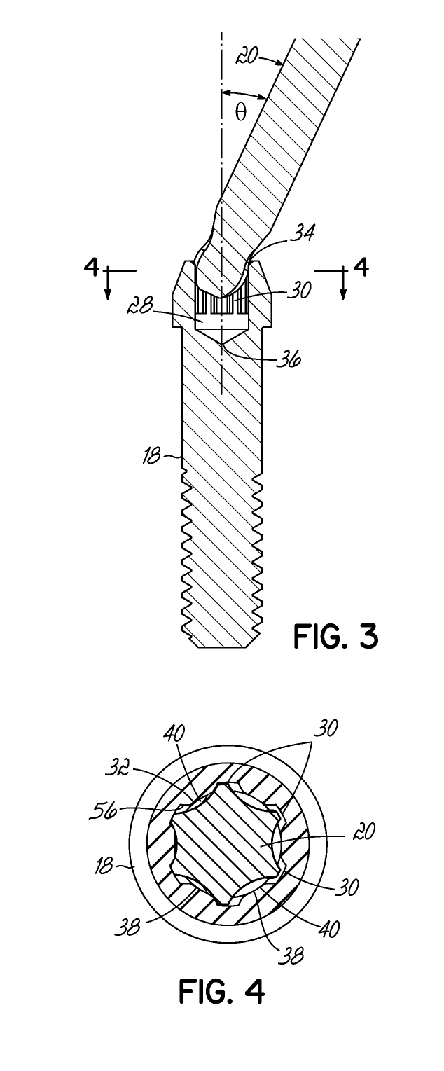

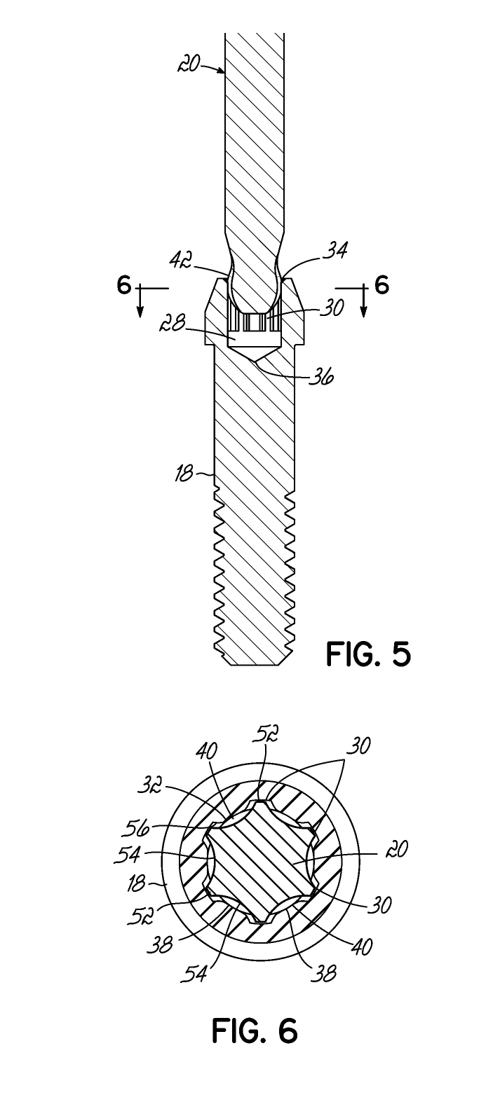

FIGS. 2A and 2B provide a detail view of ball-point hex driver 20 being engaged with fixation screw 18. Fixation screw 18 has an apical end 24 and a coronal end 26. As best shown in FIGS. 3-6, bore 28 runs from the coronal end 26 of the screw 18 along a portion of the screw 18 towards the apical end 24. A plurality of recesses 30 is arranged circumferentially around an inside surface 32 of the bore 28, and each recess 30 traverses the distance between the coronal end 34 of the bore 28 and the apical end 36 of the bore 28. Each successive pair of recesses 30 may be connected by a contact surface 38 on the inside surface 32 of the bore 28. Contact surfaces 38 may include flat portions 40, which allow a standard straight hex tool (not shown) to be used, if desired.

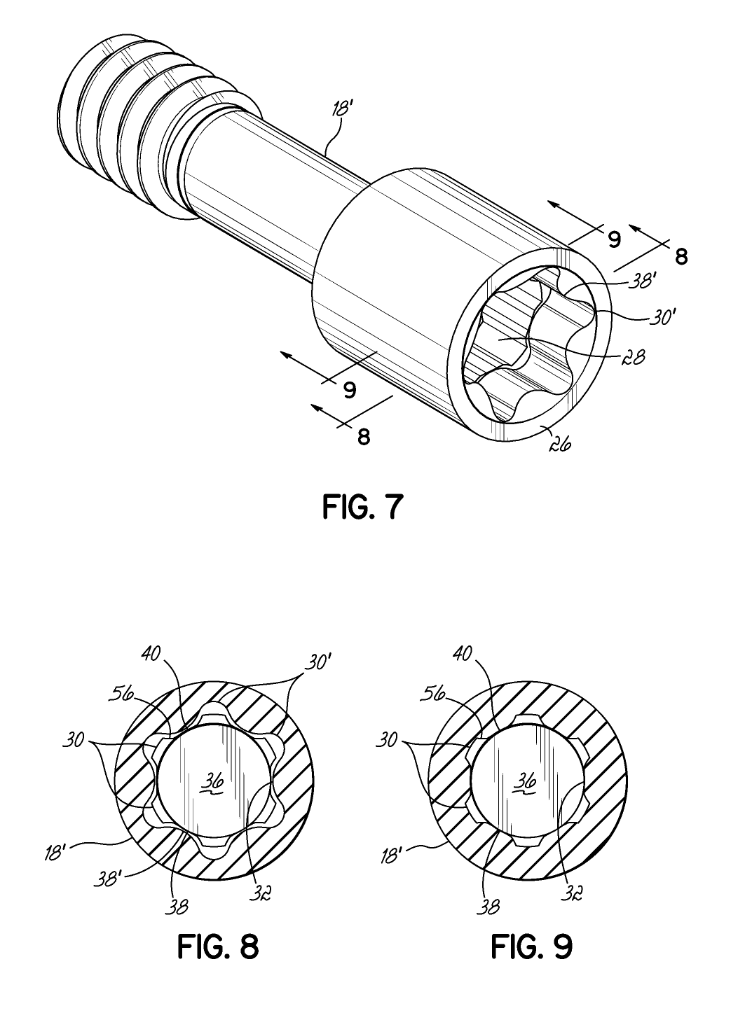

An alternative embodiment of the fixation screw 18′ is shown in FIGS. 7-9. Fixation screw 18′ is adapted for use with either a conventional driver (not shown) or ball-point hex driver 20 in accordance with the present invention. As best shown in FIG. 8, fixation screw 18′ includes two sets of recesses 30, 30′ and contact surfaces 38, 38′. Recesses 30 and contact surfaces 38, which may include flat portions 40, are proximate apical end 36 of bore 28. Recesses 30′, each successive pair of which may be connected by a contact surface 38′, are proximate coronal end 34 of bore 28. Thus, in this embodiment, the bore 28 includes a first bore portion 28a and a second bore portion 28b. The first bore portion 28a includes a first set of recesses 30′ and contact surfaces 38′, and the second bore portion 28b includes a second set of recesses 30 and contact surfaces 38. The configuration of the first bore portion 28a and second bore portion 28b may be different from each other, as illustrated in the figures.

As noted above, flat portions 40 allow a standard hex tool to be used, if desired. Although ball-point hex driver 20 can be used to drive screw 18 when flat portions 40 are present, the contact that ball-point hex driver 20 makes with fixation screw 18 during such driving may be strengthened by increasing the points of contact available between ball-point hex driver 20 and the inside surface 32 of bore 28. The advantage of including two sets of recesses 30, 30′ and contact surfaces 38, 38′ in the bore 28 of fixation screw 18′ is that the set of recesses 30 and contact surfaces 38 allow good contact with a standard hex tool (not shown) while the set of recesses 30′ and contact surfaces 38′ allow increased contact between ball-point hex driver 20 and the inside surface 32 of bore 28. Thus, the dental practitioner is able to use one type of screw for both applications in which a standard hex tool is desirable and in applications in which ball-point hex driver 20 is desirable.

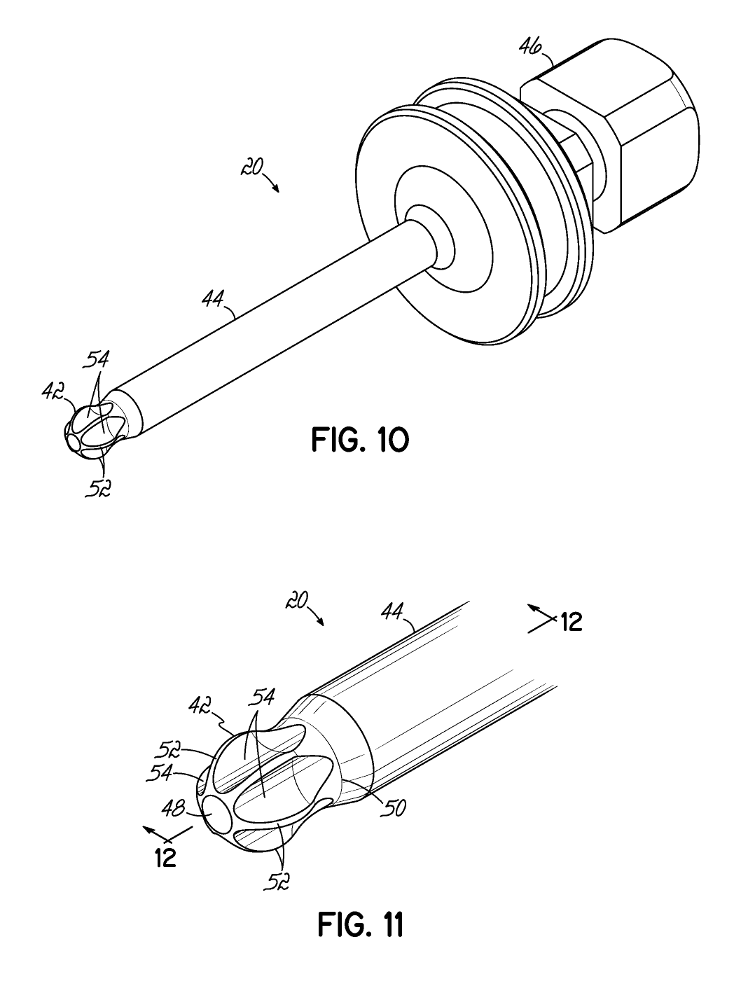

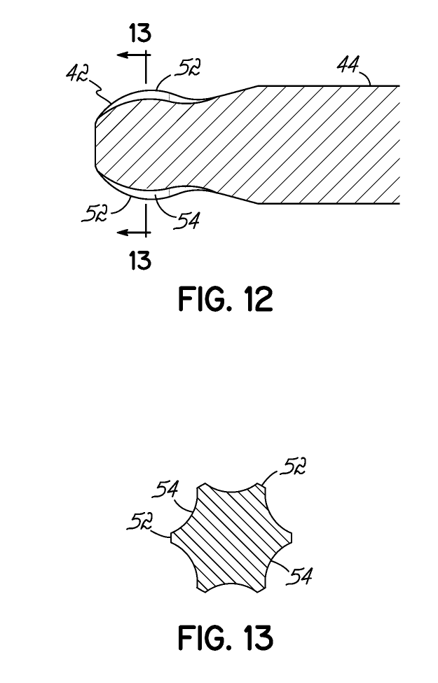

As best shown in FIGS. 10-13, ball-point hex driver 20 includes a driver head portion 42, a shaft portion 44, and a handle portion 46. The driver head portion 42 has an apical end 48 and a coronal end 50. Additionally, the driver head portion 42 has a plurality of edges 52 with a rounded outer shape extending from the apical end 48 to the coronal end 50 of the driver head portion 42. For example, each edge 52 may extend in a direction generally parallel to a longitudinal axis of the shaft portion 44 and may be convex in this direction. In this regard, the radial extent of the edges 52 at an intermediate region between the apical and coronal ends may be greater than the radial extent of the edge at the apical and coronal ends. This gives the head portion 42 a generally bulbous shape. Extending between two successive edges 52 is surface 54, which has a generally concave shape in a direction generally transverse to the longitudinal axis of the shaft 44 between the edges 52 and extends from the apical end 48 to the coronal end 50 of the driver head portion 42. Moreover, in a direction generally parallel to the longitudinal axis, the surfaces 54 may have a generally elliptical configuration. In this regard, for each of the plurality of surfaces 54, the width (e.g., in a direction generally transverse to the longitudinal axis) of a surface at an intermediate region between the apical and coronal ends is greater than the width of the surface at the apical and coronal ends. This pattern of edges 52 and surfaces 54 produces a star-shaped geometry of the cross-section taken perpendicular to the longitudinal axis of driver head portion 42, as shown in FIG. 13.

In operation, as driver head portion 42 engages with bore 28 of fixation screw 18, edges 52 fit into recesses 30, while surfaces 54 align with contact surfaces 38. In this manner, the rotation of ball-point hex driver 20 may be used to rotate fixation screw 18 to insert or remove fixation screw 18 from the subject undergoing a dental procedure. As best shown in FIGS. 3-6, when driver 20 is used at any angle θ, at least some edges 52 may contact sides 56 of contact surface 38 of bore 28 in order to drive fixation screw 18. In this way, there may be an increased engagement of the driver with the screw, thereby achieving a higher driving torque without needing to increase the overall diameter of the components.

While the present invention has been illustrated by the description of one or more embodiments thereof, and while the embodiments have been described in considerable detail, they are not intended to restrict or in any way limit the scope of the appended claims to such detail. The various features shown and described herein may be used alone or in any combination. Additional advantages and modifications will readily appear to those skilled in the art. The invention in its broader aspects is therefore not limited to the specific details, representative apparatus and method and illustrative examples shown and described. Accordingly, departures may be from such details without departing from the scope of the general inventive concept.

What is claimed is:

1. A driver tool for driving a screw for fastening a dental component to a dental implant, comprising:
a driver shaft portion having a longitudinal axis; and
a driver head coupled to the shaft portion and having an apical and a coronal end, the driver head including a plurality of edges with a rounded outer shape and a plurality of surfaces extending between successive edges, wherein the surfaces between the edges are generally concave.

2. The driver tool according to claim 1, wherein each of the plurality of edges extends in a direction generally parallel to the longitudinal axis.

3. The driver tool according to claim 1, wherein each of the plurality of edges is generally convex in a direction generally parallel to the longitudinal axis.

4. The driver tool according to claim 1, wherein for each of the plurality of edges, the radial extent of the edge at an intermediate region between the apical and coronal ends is greater than the radial extent of the edge at the apical and coronal ends.

5. The driver tool according to claim 1, wherein each of the plurality of surfaces is generally concave in a direction generally transverse to the longitudinal axis.

6. The driver tool according to claim 1, wherein each of the plurality of surfaces has a generally elliptical configuration in a direction generally parallel to the longitudinal axis.

7. The driver tool according to claim 1, wherein for each of the plurality of surfaces, the width of a surface at an intermediate region between the apical and coronal ends is greater than the width of the surface at the apical and coronal ends.

8. The driver tool according to claim 1, wherein each of the plurality of edges and surfaces extends from the apical end to the coronal end of the driver head.

9. The driver tool according to claim 1, wherein the driver head includes six edges and six surfaces.

10. A combination for fastening a dental component to a dental implant, comprising:
a screw having an apical and a coronal end, the screw comprising:
a bore extending from the coronal end of the screw toward the apical end; and
a plurality of recesses circumferentially arranged on an inside surface of the bore and extending from a coronal end of the bore toward an apical end of the bore, wherein each successive pair of recesses is connected by a contact surface on the inside surface of the bore; and
a driver tool, the driver tool comprising:
a driver shaft portion having a longitudinal axis; and
a driver head coupled to the shaft portion and having an apical and a coronal end, the driver head including a plurality of edges with a rounded outer shape and a plurality of surfaces extending between successive edges, wherein the surfaces between the edges are generally concave.

11. The combination according to claim 10, wherein each of the plurality of edges extends in a direction generally parallel to the longitudinal axis.

12. The combination according to claim 10, wherein each of the plurality of edges is generally convex in a direction generally parallel to the longitudinal axis.

13. The combination according to claim 10, wherein for each of the plurality of edges, the radial extent of the edge at an intermediate region between the apical and coronal ends is greater than the radial extent of the edge at the apical and coronal ends.

14. The combination according to claim 10, wherein each of the plurality of surfaces is generally concave in a direction generally transverse to the longitudinal axis.

15. The combination according to claim 10, wherein each of the plurality of surfaces has a generally elliptical configuration in a direction generally parallel to the longitudinal axis.

16. The combination according to claim 10, wherein for each of the plurality of surfaces, the width of a surface at an intermediate region between the apical and coronal ends is greater than the width of the surface at the apical and coronal ends.

17. The combination according to claim 10, wherein each of the plurality of edges and surfaces extends from the apical end to the coronal end of the driver head.

18. The combination according to claim 10, wherein the driver head includes six edges and six surfaces.

19. The combination according to claim 10, wherein the bore has a first bore portion having a first set of plurality of recesses and contact surfaces, and a second bore portion having a second set of plurality of recesses and contact surfaces.

20. The combination according to claim 19, wherein the configuration of the first bore portion and the second bore portion is different from each other.

21. The combination according to claim 19, wherein the first bore portion extends from the coronal end to an intermediate region between the coronal and apical ends.

22. The combination according to claim 21, wherein the second bore portion extends from the intermediate region toward the apical end.

23. A screw for fastening a dental component to a dental implant, the screw comprising:
a bore extending from a coronal end of the screw toward an apical end of the screw, the bore having a first bore portion extending from the coronal end of the screw toward an intermediate region of the bore, and a second bore portion extending from the intermediate region of the bore toward an apical end of the bore,
wherein the first bore portion includes a first set of a plurality of recesses circumferentially arranged on an inside surface of the bore, each successive pair of recesses connected by a contact surface on the inside surface of the bore,
wherein the second bore portion includes a second set of a plurality of recesses circumferentially arranged on an inside surface of the bore, each successive pair of recesses connected by a contact surface on the inside surface of the bore, and
wherein the configuration of the first bore portion and the second bore portion is different from each other.
